(19) United States
(12) Patent Application Publication
(10) Pub. No.: US 2013/0312530 A1
(43) Pub. Date: Nov. 28, 2013

(54) ULTRASONIC PROBE AND ULTRASONIC DISPLAY DEVICE

(71) Applicant: GE Medical Systems Global Technology Company, LLC, Waukesha, WI (US)

(72) Inventor: Tsutomu Kawaguchi, Tokyo (JP)

(73) Assignee: GE Medical Systems Global Technology Company, LLC, Waukesha, WI (US)

(21) Appl. No.: 13/900,352

(22) Filed: May 22, 2013

(30) Foreign Application Priority Data
May 23, 2012 (JP) 2012-117269

(51) Int. Cl. G01N 29/24

(52) U.S. Cl. CPC G01N 29/24
USPC 73/661

(57) ABSTRACT

An ultrasonic probe is provided. The ultrasonic probe includes an impact detection unit configured to electrically detect an impact applied to the ultrasonic probe, a power supply unit configured to supply power required for impact detection by the impact detection unit, and a storage unit configured to store information on the impact detected by the impact detection unit.

### CROSS REFERENCE TO RELATED APPLICATIONS

This application claims the benefit of Japanese Patent Application No. 2012-117269 filed May 23, 2012, which is hereby incorporated by reference in its entirety.

### BACKGROUND OF THE INVENTION

The present invention relates to an ultrasonic probe for transmitting ultrasonic waves to an object to be tested and an ultrasonic display device for displaying an ultrasonic image.

An ultrasonic display device displays an ultrasonic image based on ultrasonic echo signals obtained by transmitting ultrasonic waves to an object to be tested. Such an ultrasonic display device transmits/receives ultrasonic waves using an ultrasonic probe coupled to the main unit of the display device via a probe cable (see for example, JP-A No. 2011-10664).

The ultrasonic probe has a complicated inner structure and it may develop a fault, for example, when dropped on the floor or otherwise subjected to a strong impact. Even when the ultrasonic probe is subjected to a strong impact, the impact cannot be electrically memorized, for example, when, without the ultrasonic probe coupled to the display device main unit, the display device main unit cannot energize the ultrasonic probe or when the ultrasonic probe coupled to the display device main unit has not been energized.

### BRIEF DESCRIPTION OF THE INVENTION

The embodiments described herein provide an ultrasonic probe which includes an impact detection unit for electrically detecting an impact applied to the ultrasonic probe, a power supply unit for supplying power required for impact detection by the impact detection unit, and a storage unit for storing information on an impact detected by the impact detection unit.

According to the embodiments described herein, the ultrasonic probe has the impact detection unit, the power supply unit, and the storage unit, so that, even in a state where the ultrasonic probe is not electrically coupled to the ultrasonic display device main unit, an impact applied to the ultrasonic probe can be electrically detected and memorized.

### BRIEF DESCRIPTION OF THE DRAWINGS

FIG. 1 is a block diagram of an ultrasonic image display device according to a first embodiment.

FIG. 2 is a block diagram of an ultrasonic image display device according to a second embodiment.

### DETAILED DESCRIPTION OF THE INVENTION

Embodiments of will be described in the following description.

### First Embodiment

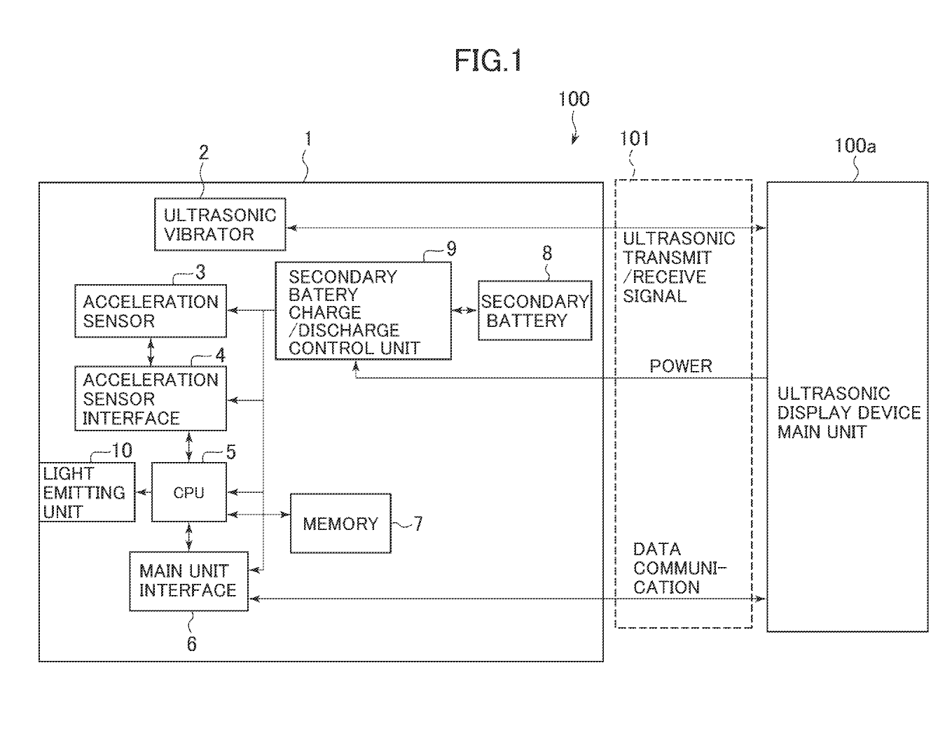

A first embodiment will be described below with reference to FIG. 1. As shown in FIG. 1, an ultrasonic display device 100 according to the first embodiment is, for example, an ultrasonic diagnostic device for displaying an ultrasonic image such as a B-mode image of a patient or an ultrasonic flaw detector for non-destructive inspection. The ultrasonic display device 100 is not, however, limited to such devices as long as it is provided with an ultrasonic probe discrete from the ultrasonic display device main unit.

The ultrasonic display device 100 includes an ultrasonic display device main unit 100a and an ultrasonic probe 1 coupled to the main unit 100a via a probe cable 101.

The ultrasonic display device main unit 100a generates an ultrasonic image based on ultrasonic echo signals obtained by the ultrasonic probe 1 and displays the generated ultrasonic image.

The ultrasonic probe 1 has an ultrasonic vibrator 2 formed of a piezoelectric material such as PZT (piezoelectric zirconate titanate). The ultrasonic display device main unit 100a supplies the ultrasonic vibrator 2 with an electric signal for ultrasonic wave transmission. The ultrasonic waves transmitted from the ultrasonic vibrator 2 to an object and reflected from the object to the ultrasonic vibrator 2 are converted into an electric signal at the ultrasonic vibrator 2 to be then inputted to the ultrasonic display device main unit 100a.

The ultrasonic probe 1 includes an acceleration sensor 3, an acceleration sensor interface 4, a CPU (Central Processing Unit) 5, a main unit interface 6, and a memory 7. The acceleration sensor 3 electrically detects acceleration applied to the ultrasonic probe 1 making it possible to detect an impact if applied to the ultrasonic probe 1. The acceleration sensor 3 is an exemplary embodiment of an impact detection unit.

The CPU 5 communicates with the acceleration sensor 3 via the acceleration sensor interface 4. The CPU 5 communicates with the ultrasonic display device main unit 100a via the main unit interface 6. The main unit interface 6 is an exemplary embodiment of an information output unit.

The memory 7 is a semiconductor memory, such as a non-volatile memory. The CPU 5 stores the value of acceleration detected by the acceleration sensor 3 in the memory 7. The acceleration stored in the memory 7 is read out by the CPU 5 for output to the ultrasonic display device main unit 100a via the main unit interface 6. The memory 7 is an exemplary embodiment of a storage unit. The acceleration is an exemplary embodiment of impact information.

The ultrasonic probe 1 is provided with a secondary battery 8 and a secondary battery charge/discharge control unit 9. The secondary battery charge/discharge control unit 9 controls charging and discharging of the secondary battery 8. The secondary battery charge/discharge control unit 9 makes the secondary battery 8 supply power to the acceleration sensor 3, acceleration sensor interface 4, CPU 5, and main unit interface 6. The secondary battery 8 is an exemplary embodiment of a power supply unit.

In the present embodiment, with the ultrasonic probe 1 coupled to the ultrasonic display device main unit 100a, the secondary battery 8 is charged by the power supplied from the ultrasonic display device main unit 100a.

The ultrasonic probe 1 is further provided with a light emitting unit 10 which is, for example, an LED (Light Emitting Diode). The light emitting unit 10 emits light when the acceleration detected by the acceleration sensor 3 exceeds a predetermined threshold TH. The emission of light by the light emitting unit 10 is controlled by the CPU 5. The light emitting unit 10 is an exemplary embodiment of an annunciation unit.

The operation for impact detection by the ultrasonic probe 1 according to the present embodiment will be described below. The impact detection operation described below is based on example cases where, without the ultrasonic probe 1 coupled to the display device main unit 100a, the display device main unit 100a cannot energize the ultrasonic probe 1 or where the ultrasonic probe 1 coupled to the display device main unit 100a has not been energized.

When the ultrasonic probe 1 is subjected to an impact, the acceleration sensor 3 detects the impact by detecting acceleration of the ultrasonic probe 1. The power required by the acceleration sensor 3 to detect acceleration of the ultrasonic probe 1 is supplied by the secondary battery 8.

The CPU 5 communicates with the acceleration sensor 3 via the acceleration sensor interface 4. When the acceleration detected by the acceleration sensor 3 exceeds the threshold TH, the detected acceleration is stored as impact information in the memory 7. Instead of the detected acceleration, information indicating that the detected acceleration exceeded the threshold TH may be stored as the impact information.

The threshold TH represents a value of impact which is considered to be large enough to possibly damage an inner part of the ultrasonic probe 1, that is, when the ultrasonic probe 1 is subjected to such an impact, one can perform fault diagnosis on the ultrasonic probe 1.

With the ultrasonic probe 1 coupled to the ultrasonic display device main unit 100a via the probe cable 101, the acceleration memorized in the memory 7 is read out by the CPU 5 for input to the ultrasonic display device main unit 100a via the main unit interface 6 and the probe cable 101.

The acceleration inputted to the ultrasonic display device main unit 100a may be displayed in a display part (not shown) of the ultrasonic display device main unit 100a. Also, a message informing of detection of an acceleration exceeding the threshold TH may be displayed in the display part of the ultrasonic display device main unit 100a. Such information displayed on the ultrasonic display device main unit 100a can be made use of in performing fault diagnosis on the ultrasonic probe 1.

When an acceleration exceeding the threshold TH is detected, the CPU 5 makes the light emitting unit 10 emit light. At this time, the CPU 5 may make the light emitting unit 10 blink the light. The emission of light will let the operator of the ultrasonic display device know that an acceleration exceeding the threshold TH has been detected meaning that the ultrasonic probe 1 was subjected to an impact exceeding a certain magnitude.

According to the present embodiment described above, even in a state in which the ultrasonic probe 1 is not electrically coupled to the ultrasonic image display device main unit 100a, supplying power from the secondary battery 8 to the acceleration sensor 3 makes it possible to detect acceleration of the ultrasonic probe 1 and store information, for example, on an acceleration exceeding the threshold TH in the memory 7.

### Second Embodiment

A second embodiment will be described below. In the following description of the second embodiment, parts identical to those used in the first embodiment will be denoted by reference signs identical to those used in the first embodiment and detailed description of such parts will be omitted.

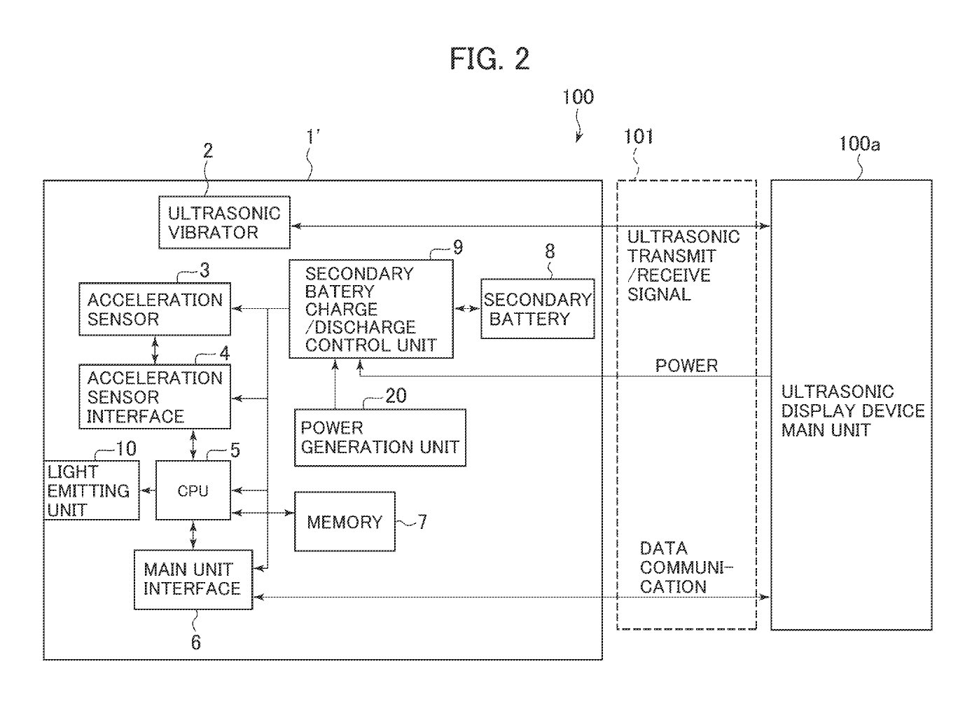

In the second embodiment, as shown in FIG. 2, the ultrasonic probe 1′ includes a power generation unit 20. The power generation unit 20 is, for example, a solar battery or a generator which can convert vibrations into electric power. The power generated by the power generation unit 20 is charged to the secondary battery 8 via the secondary battery charge/discharge control unit 9. Thus, in the present embodiment, besides the ultrasonic display device main unit 100a, the power generation unit 20 can also charge the secondary battery 8. Namely, the secondary battery 8 can be charged by the power generation unit 20 even in a state where the ultrasonic probe 1 is not coupled to the ultrasonic display device main unit 100a. Additionally, the present embodiment has the same advantages as those of the first embodiment.

Even though exemplary embodiments have been described above, the disclosure is not limited to the above embodiments and can be modified in many ways within the scope and spirit of the invention. For example, the impact detection unit for electrically detecting an impact applied to the ultrasonic probe 1 is not limited to the acceleration sensor 3. The impact detection unit may be, for example, a switch which can be mechanically closed, by an impact applied thereto, to allow electric current to flow therethrough. The switch can be set to turn on when subjected to an impact exceeding a predetermined magnitude so as to cause electric current to flow through the switch and the flowing of electric current through the switch may be memorized as impact information in the memory 7.

The power supply unit for supplying power to the acceleration sensor 3 and other parts is not limited to the secondary battery 8. For example, it may be a primary battery.

1. An ultrasonic probe, comprising;
an impact detection unit configured to electrically detect an impact applied to the ultrasonic probe,
a power supply unit configured to supply power required for impact detection by the impact detection unit, and
a storage unit configured to store information on the impact detected by the impact detection unit.

2. The ultrasonic probe according to claim 1, further comprising an information output unit configured to output the stored information on the impact to an ultrasonic display device main unit coupled with the ultrasonic probe.

3. The ultrasonic probe according to claim 1, wherein the power supply unit is a secondary battery.

4. The ultrasonic probe according to claim 2, wherein the power supply unit is a secondary battery.

5. The ultrasonic probe according to claim 3, wherein the secondary battery is configured to be charged by power supplied from an ultrasonic display device main unit coupled with the ultrasonic probe.

6. The ultrasonic probe according to claim 4, wherein the secondary battery is configured to be charged by power supplied from the ultrasonic display device main unit.

7. The ultrasonic probe according to claim 3, further comprising a power generation unit configured to charge the secondary battery.

8. The ultrasonic probe according to claim 4, further comprising a power generation unit configured to charge the secondary battery.

9. The ultrasonic probe according to claim 5, further comprising a power generation unit configured to charge the secondary battery.

10. The ultrasonic probe according to claim 6, further comprising a power generation unit configured to charge the secondary battery.

11. The ultrasonic probe according to claim 1, wherein the impact detection unit is an acceleration sensor.

12. The ultrasonic probe according to claim 2, wherein the impact detection unit is an acceleration sensor.

13. The ultrasonic probe according to claim 3, wherein the impact detection unit is an acceleration sensor.

14. The ultrasonic probe according to claim 4, wherein the impact detection unit is an acceleration sensor.

15. The ultrasonic probe according to claim 5, wherein the impact detection unit is an acceleration sensor.

16. The ultrasonic probe according to claim 6, wherein the impact detection unit is an acceleration sensor.

17. The ultrasonic probe according to claim 11, wherein, when an acceleration exceeding a predetermined threshold is detected by the acceleration sensor, impact information is stored in the storage unit.

18. The ultrasonic probe according to claim 1, further comprising an annunciation unit, configured to make an annunciation when an impact is detected by the impact detection unit.

19. An ultrasonic display device, comprising the ultrasonic probe according to claim 1.

20. An ultrasonic display device, comprising the ultrasonic probe according to claim 2.
